(19) United States
(12) Patent Application Publication
(10) Pub. No.: US 2025/0288150 A1
(43) Pub. Date: Sep. 18, 2025

(54) Air Fryer/Oven

(71) Applicant: XIAMEN MYLUX INTELLIGENT TECHNOLOGY Co., LTD, Xiamen (CN)

(72) Inventor: Yiyun Zhou, Xiamen (CN)

(21) Appl. No.: 18/898,715

(22) Filed: Sep. 27, 2024

(30) Foreign Application Priority Data
Mar. 18, 2024 (CN) 2024205229590
Apr. 18, 2024 (CN) 2024208113878
Apr. 18, 2024 (CN) 2024208113948
Jul. 12, 2024 (CN) 2024216506012

(51) Int. Cl. A47J 37/06

(52) U.S. Cl. CPC A47J 37/0641

(57) ABSTRACT

The present invention provides an air fryer/oven, which relates to the technical field of household appliances. The air fryer includes a body and a heating component, wherein the body has a cooking chamber arranged therein, and a window arranged thereon and communicated with the cooking chamber, wherein the heating component is detachably arranged in the window and is used to heat the cooking chamber. The present invention has a window is opened and arranged on the body of the air fryer for installing the heating component, and when the heating component needs to be cleaned, the heating component is allowed to be directly disassembled from the window, which is simple and convenient to operate, and effectively overcomes the problems of inconvenient disassembly and cumbersome operation of the heating component in the prior art.

### BACKGROUND OF THE PRESENT INVENTION

### Field of Invention

The present invention relates to the technical field of household appliances, in particular to an air fryer/oven.

### Description of Related Arts

Air fryer is a kind of kitchen cooking appliance that uses high-temperature air to fry food. The food made in an air fryer has lower fat content compared to traditionally fried food, making it highly favored by people. The heating component of an air fryer includes a motor, an electric heating tube, a fan, and other components, and during the cooking process, the oil smoke and water vapor generated by the air fryer will enter the heating component and adhere to the surface of the electric heating tube or fan. However, the conventional heating component is usually fixed on the body of the air fryer as a whole, and cannot be disassembled and cleaned. Therefore, the oil stains inside the heating component will accumulate more and more, which will eventually cause the air fryer to produce peculiar odor and affect people's dietary health.

In order to solve the problem of cleaning the air fryer, the Chinese patent with the publication number of CN214387234U discloses a detachable heating component for the air fryer. The heating component of this solution is detachably installed on the machine cover through the fasteners and locks that match each other. At the same time, the heating tube is connected to the power supply by adopting the mode of power connector and socket matching, so that the heating component can be quickly disassembled and assembled, and the inside of the heating component can be easily cleaned.

However, there are several shortcomings in this solution: firstly, this solution places the heating component on the machine cover, which not only makes the volume of the machine cover larger, but also requires the entire machine cover to be turned up or removed when the heating component needs to be cleaned, and then the heating component is removed from the machine cover, so the operation is more cumbersome; secondly, this solution is equipped with a cooling fan for the motor, but after disassembly, the cooling fan is wrapped inside the machine cover, so the cooling fan cannot be cleaned, resulting in incomplete cleaning; thirdly, the arrangement of the machine cover in this solution makes the structure of the air fryer more complex, and also affects the overall aesthetics of the air fryer.

In addition to the air fryer, the oven is also a common kitchen appliance in life. Its working principle is to use the radiant heat emitted by the electric heating element to bake food, which can be used to make barbecue, bake bread and pastries, etc., which are also favored by people. The conventional oven on the market usually includes a box body, a baking cavity and a heating component. The heating component is installed in the baking cavity and used to heat the baking cavity. During the cooking process of food, the oil smoke and water vapor generated will adhere to the heating component, and therefore need to be cleaned regularly. However, the heating component of a conventional oven is usually fixed in the baking cavity and cannot be disassembled and cleaned. Therefore, the oil stains inside the heating component will continue to accumulate, eventually causing a peculiar odor in the oven and affecting people's dietary health. It can be seen that the conventional oven also have the problem that the heating component is not removable and are difficult to clean, so a solution is urgently needed.

### SUMMARY OF THE PRESENT INVENTION

The present invention provides an air fryer/oven, the main purpose of which is to solve the problems existing in the air fryer/oven in the prior art. In order to solve the problem, the present invention proposes four technical solutions based on the overall inventive concept of detachable heating components. The implementation details and advantageous effects of each technical solution are introduced below.

The details of the first technical solution provided by the present invention are as follows:

An air fryer, includes a body and a heating component, wherein the body has a cooking chamber arranged therein, and a window arranged thereon and communicated with the cooking chamber, wherein the heating component is detachably arranged in the window and is used to heat the cooking chamber.

Further, the heating component includes a heating tube, a uniform heating fan, and a fixed cover, wherein the fixed cover is detachably arranged in the window, and the heating tube and the uniform heating fan are arranged at a bottom of the fixed cover, wherein the body has a motor arranged therein and connected with the uniform heating fan in a transmission manner and a connecting component arranged thereon and electrically connected with the heating tube.

Further, the heating component further includes a cooling fan, wherein the cooling fan is arranged at a top of the fixed cover, and the cooling fan and the uniform heating fan are connected with the motor through a same rotating shaft in a transmission manner.

Further, the heating component further includes an upper protective cover arranged above the fixed cover, and a first cavity for installing the cooling fan arranged between the upper protective cover and the fixed cover, wherein the upper protective cover has a plurality of first hollow portions arranged in the middle thereof and connected with the first cavity and a plurality of heat dissipation holes arranged on a side wall thereof.

Further, the heating component further includes a lower protective cover arranged below the fixed cover, and a second cavity for installing the heating tube and the cooling fan arranged between the lower protective cover and the fixed cover, wherein the lower protective cover has a plurality of second hollow portions arranged thereon and connected with the second cavity.

Further, the heating tube is installed on the fixed cover through a plurality of L-shaped brackets and is located below the uniform heating fan.

Further, the connecting component includes a socket and a power connector that match each other, wherein the socket is arranged in the cooking chamber, wherein the power connector arranged at an end part of the heating tube and extends to the outside of the fixed cover.

Further, the body has a track arranged on each of two sides therein, wherein the upper protective cover has an annular convex platform that cooperates with the track and is arranged on an outer peripheral edge thereof.

Further, the body has an independent installation cavity arranged above the cooking chamber, and an overhaul cover arranged to close and fit with the installation cavity, wherein the motor is installed in the installation cavity through a mounting bracket, and an output shaft of the motor is connected with the rotating shaft through a clutch.

Further, the cooking chamber has an opening toward one side of the body, and the window is opened on the other side of the body.

Compared with the prior art, the beneficial effects produced by the first technical solution are:
1. The window is opened and arranged on the body of the air fryer for installing the heating component, and when the heating component needs to be cleaned, the heating component is allowed to be directly disassembled from the window, which is simple and convenient to operate, and effectively overcomes the problems of inconvenient disassembly and cumbersome operation of the heating component in the prior art.
2. The cooling fan of the air fryer is arranged on the top of the fixed cover and coaxially connected with the uniform heating fan. Therefore, when the fixed cover is taken out, the cooling fan will be removed along with the uniform heating fan and the heating tube, so that the cooling fan can be cleaned, which is helpful to remove the oil stain more comprehensively and thoroughly.
3. The overall layout of the heating component of the air fryer is exquisite and requires small installation space. Therefore, the position of the window can be flexibly designed according to specific needs without affecting the overall aesthetics.

The details of the second technical solution provided by the present invention are as follows:

An air fryer, includes a body, a cover and a heating component, wherein the body has a cooking chamber arranged therein, and an installation window arranged thereon and communicated with the cooking chamber, wherein the heating component is detachably arranged in the installation window and is used to heat the cooking chamber, wherein the cover and the body are closed or separated from each other to close or open the installation window.

Further, the installation window has a support portion arranged therein, and the heating component is placed above the support portion.

Further, the body has a plurality of heat dissipation holes arranged on the side of the heating component.

Further, the heating component includes a fixed cover and a heating tube and a uniform heating fan arranged at a bottom of the fixed cover, wherein a connecting component electrically connected with the heating tube is provided in the installation window, wherein the cover has a motor and a transmission component arranged therein for driving the uniform heating fan.

Further, the heating component further includes a cooling fan arranged on a top of the fixed cover, wherein the cooling fan and the uniform heating fan are connected with the transmission component through a same rotating shaft.

Further, the heating component further includes a protective cover arranged above the fixed cover, and a cavity for installing the cooling fan arranged between the protective cover and the fixed cover, wherein the protective cover has a plurality of exhaust holes and a plurality of water outlet holes arranged thereon and communicated with the cavity.

Further, the cover has an installation cavity disposed therein, wherein the motor is arranged in the installation cavity and connected with the rotating shaft through the transmission component.

Further, the transmission component includes a first transmission component and a second transmission component that are allowed to be separated or connected to each other, wherein the first transmission component is provided on an output shaft of the motor, and the second transmission component is provided on the rotating shaft.

Further, the first transmission component and the second transmission component are respectively a first clutch and a second clutch; the first transmission component and the second transmission component are respectively a first push rod and a second push rod; or the first transmission component and the second transmission component are respectively a first magnetic component and a second magnetic component.

Further, a connection method between the cover and the body is a flip hinge connection, a snap connection, a rotating cover connection or a horizontal sliding connection.

Compared with the prior art, the beneficial effects produced by the second technical solution are:
1. The body of the air fryer has an installation window opened and arranged thereon for installing the heating component, and the body has a cover arranged thereon for opening or closing the installation window. When the heating component needs to be cleaned, the cover only needs to be opened, and the whole heating component can be taken out from the installation window for cleaning, which is simple and convenient to operate. The problems in the prior art that the heating component of the air fryer is inconvenient to disassemble, and the operation is cumbersome are effectively overcome. Since the heating component is disposed in the installation window, the volume of the cover is smaller, and the structural design is more exquisite and beautiful.
2. The cooling fan of the air fryer is arranged on the top of the fixed cover and coaxially connected with the uniform heating fan. Therefore, when the fixed cover is taken out, the cooling fan will be removed along with the uniform heating fan and the heating tube, so that the cooling fan can be cleaned, which is helpful to remove the oil stain more comprehensively and thoroughly.
3. The connection methods between the cover and the body of the air fryer include, but are not limited to, a flip hinge connection, a snap connection, a rotating cover connection, and a horizontal sliding connection, so the structure is more flexible and rich to meet the diversified needs of people.

The details of the thirdly technical solution provided by the present invention are as follows:

An air fryer, includes an upper pot body, a lower pot body, an upper heating component, and a cooking container, wherein the upper pot body and the lower pot body are covered or separated from each other to form a cooking chamber with different cooking functions, wherein the cooking container is installed in the cooking chamber and used to hold ingredients, wherein the upper heating component is detachably arranged in the upper pot body and used to heat the cooking chamber.

Further, the upper heating component includes a fixed cover, a heating tube, and a uniform heating fan, wherein one side of the fixed cover is detachably arranged on the upper pot body, and the other side of the fixed cover is provided with the heating tube and the uniform heating fan, wherein the upper pot body has a connecting component disposed therein and electrically connected to the heating tube, and a motor and a transmission component disposed therein for driving the uniform heating fan.

Further, the transmission component includes a rotating shaft and a first transmission component and a second transmission component that are allowed to be separated or connected to each other, wherein the uniform heating fan is arranged on the fixed cover through the rotating shaft, the first transmission component is arranged on an output shaft of the motor, and the second transmission component is arranged on the rotating shaft.

Further, the first transmission component and the second transmission component are respectively a first clutch and a second clutch; the first transmission component and the second transmission component are respectively a first push rod and a second push rod; or the first transmission component and the second transmission component are respectively a first magnetic component and a second magnetic component.

Further, the connecting component includes a socket and a power connector that match each other, wherein the socket is arranged in the upper pot body, and the power connector is arranged at an end part of the heating tube.

Further, the air fryer further includes a protective cover and a cooling fan, wherein the protective cover is disposed between the upper pot body and the fixed cover, wherein the cooling fan is disposed between the upper pot body and the protective cover and is connected with the output shaft of the motor.

Further, the upper pot body has an installation cavity, the motor is installed in the installation cavity, and the output shaft of the motor is connected with the cooling fan and the first transmission component.

Further, the lower pot body has a lower baking tray detachably disposed therein, which has a lower heating component at the bottom thereof, wherein when the upper pot body and the lower pot body are closed to each other, the upper heating component or the lower heating component individually cooks the inside of the cooking chamber, or the upper heating component and the lower heating component cooperate with each other to cook in the cooking chamber, wherein when the upper pot body and the lower pot body are separated from each other, the lower heating component cooks the cooking chamber alone.

Further, the cooking container is a frying pot or an upper baking tray, wherein the frying pot is placed above the lower baking tray, and the upper baking tray is detachably arranged on the upper pot body and is positioned below the upper heating component.

Further, a connection method between the upper pot body and the lower pot body is a flip hinge connection, a snap connection, a rotating cover connection, a horizontal sliding connection or a vertical lifting connection.

Compared with the prior art, the beneficial effects produced by the thirdly technical solution are:
1. The upper heating component of the air fryer adopts a modular and detachable structure as a whole. Therefore, when the heating component needs to be cleaned, the upper heating component is capable of being directly removed from the upper pot body. The operation is simple and convenient, and the problem of inconvenient disassembly and cumbersome operation of the upper heating component in the prior art has been effectively overcome.
2. Different cooking functions are capable of being set according to the mutual covering or separation status of the upper pot body and lower pot body of the air fryer, and the corresponding control programs are capable of being set according to different cooking functions, so that the upper heating component and the lower heating component are capable of being used alone or in combination, thereby realizing a machine for multiple purposes to meet the diverse needs of customers.

The details of the fourthly technical solution provided by the present invention are as follows:

An oven, includes a box body and a heating component, wherein the box body has a baking cavity arranged therein, and a window arranged thereon and communicated with the baking cavity, wherein the heating component is detachably arranged in the window.

Further, the oven further includes a box door hinged with the box body for closing the baking cavity.

Further, the window has a support portion arranged therein, and the support portion has a track arranged on an edge thereof, wherein the heating component is disposed in the window along the track in a drawable manner and is arranged above the support portion.

Further, the heating component includes a fixed cover and an upper heating tube and a uniform heating fan arranged at a bottom of the fixed cover, wherein the window has a connecting component disposed therein and electrically connected with the upper heating tube, and a motor and a transmission component disposed therein and connected with the uniform heating fan in a transmission manner.

Further, the box body has a mounting groove arranged on a top thereof and connected with the window, wherein the motor is detachably arranged in the mounting groove through a mounting bracket, and is connected with the uniform heating fan through the transmission component.

Further, the transmission component includes a first transmission component and a second transmission component, which are separable or interconnectable from each other, wherein the first transmission component is disposed on an output shaft of the motor, and the second transmission component is disposed on a rotating shaft of the uniform heating fan.

Further, the oven further includes a protective cover and a cooling fan, wherein the protective cover is arranged above the fixed cover, and the cooling fan is arranged between the protective cover and the fixed cover, and is connected with the rotating shaft of the uniform heating fan.

Further, the oven further includes a protective cover and a cooling fan, wherein the protective cover is arranged at a bottom of the motor, and the cooling fan is arranged between the motor and the fixed cover, and is connected with an output shaft of the motor.

Further, the oven further includes a support cover arranged on a bottom of the mounting groove, wherein the mounting bracket has an elastic buckle arranged on each of two sides thereof, and the support cover has a hook matched to each of the elastic buckles disposed thereon.

Compared with the prior art, the beneficial effects produced by the fourthly technical solution are:

A window for installing the heating component is provided on the box body of the oven. When the heating component needs to be cleaned, the heating component is capable of being directly removed from the window. The operation is simple and convenient, and the problem of inconvenient disassembly and cumbersome operation of the heating component of the oven in the prior art has been effectively overcome.

### BRIEF DESCRIPTION OF THE DRAWINGS

FIG. 1 is a perspective view of an air fryer according to Embodiment 1 of the present invention.

FIG. 2 is an exploded view of the air fryer and the heating component according to Embodiment 1 of the present invention.

FIG. 3 is a sectional view of the air fryer according to Embodiment 1 of the present invention.

FIG. 4 is a partial sectional view of the air fryer according to Embodiment 1 of the present invention.

FIG. 5 is a bottom structural view of the heating component according to Embodiment 1 of the present invention (the lower protective cover is not shown).

FIG. 6 is a bottom structural view of the heating component according to Embodiment 1 of the present invention.

FIG. 7 is a perspective view of the air fryer according to Embodiment 2 of the present invention.

FIG. 8 is a sectional view of the air fryer when the cover is closed according to Embodiment 2 of the present invention.

FIG. 9 is a sectional view of the air fryer when the cover is opened according to Embodiment 2 of the present invention.

FIG. 10 is a sectional view of the air fryer when the heating component is taken out according to Embodiment 2 of the present invention.

FIG. 11 is a structural perspective view of the heating component according to Embodiment 2 of the present invention.

FIG. 12 is an exploded view of the heating component according to Embodiment 2 of the present invention.

FIG. 13 is a sectional view of the air fryer when the cover is closed according to Embodiment 3 of the present invention.

FIG. 14 is a sectional view of the air fryer when the cover is opened according to Embodiment 3 of the present invention.

FIG. 15 is a sectional view of the air fryer when the cover is closed according to Embodiment 4 of the present invention.

FIG. 16 is a sectional view of the air fryer when the cover is opened according to Embodiment 4 of the present invention.

FIG. 17 is a perspective view of an air fryer according to Embodiment 5 of the present invention.

FIG. 18 is a sectional view of the air fryer with the air deep-fry function according to Embodiment 5 of the present invention.

FIG. 19 is a perspective view when the upper pot body is opened in FIG. 18 (the oil isolation net is not shown).

FIG. 20 is an exploded view of the upper pot body according to Embodiment 5 of the present invention.

FIG. 21 is a structural perspective view of the upper heating component according to Embodiment 5 of the present invention.

FIG. 22 is a sectional view of the air fryer with the pan-fry and broil function according to Embodiment 5 of the present invention.

FIG. 23 is a perspective view when the upper pot body is opened in FIG. 22.

FIG. 24 is a perspective view of an oven according to Embodiment 6 of the present invention.

FIG. 25 is an exploded view of the oven and heating component according to Embodiment 6 of the present invention.

FIG. 26 is an exploded view of the heating component according to Embodiment 6 of the present invention.

FIG. 27 is a sectional view of an oven according to Embodiment 6 of the present invention.

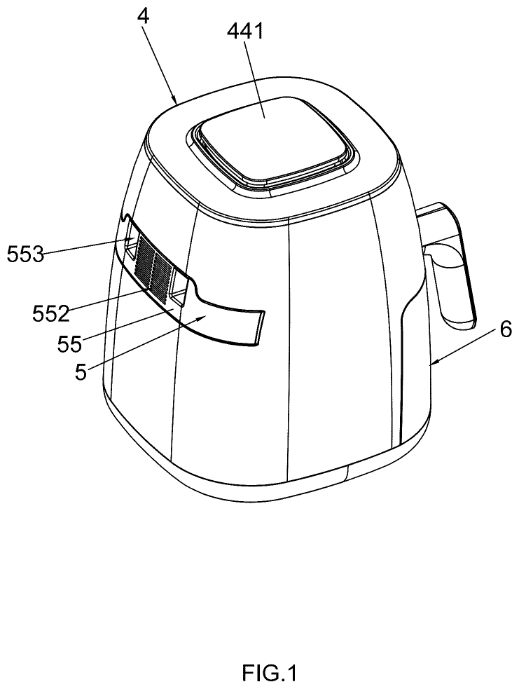

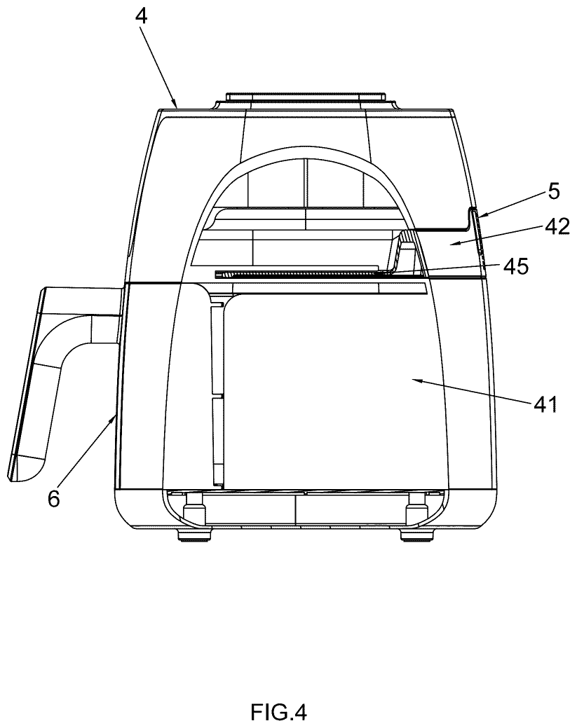

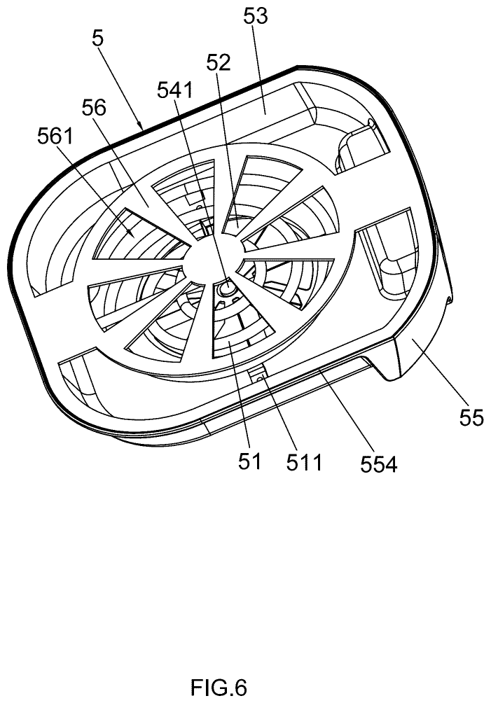

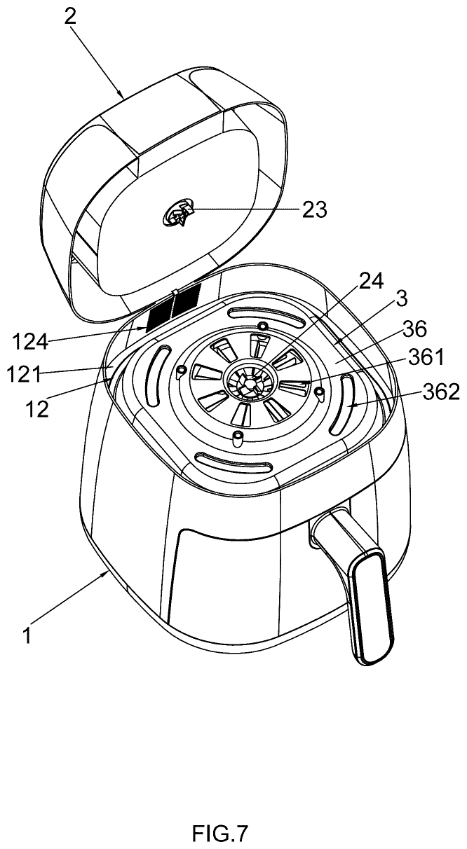

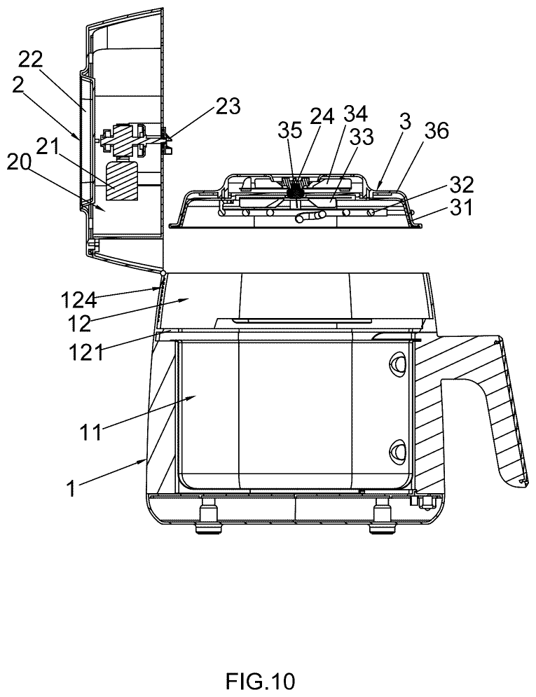

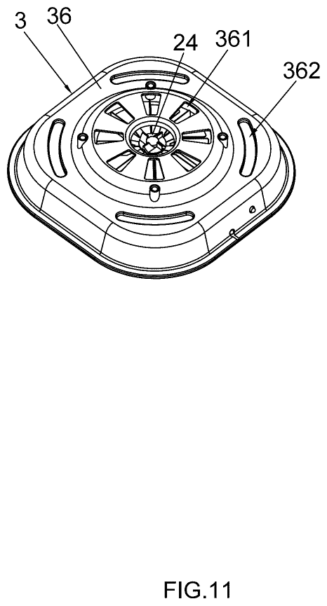

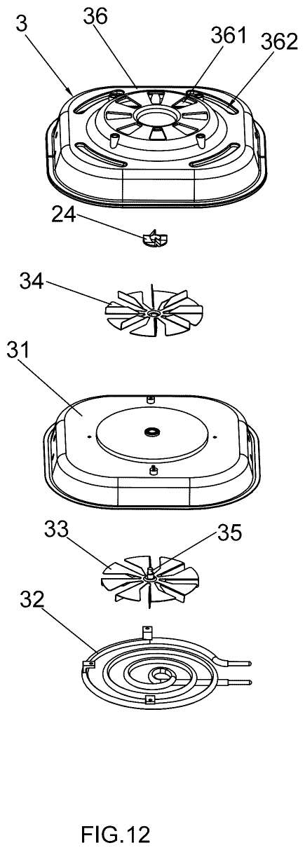

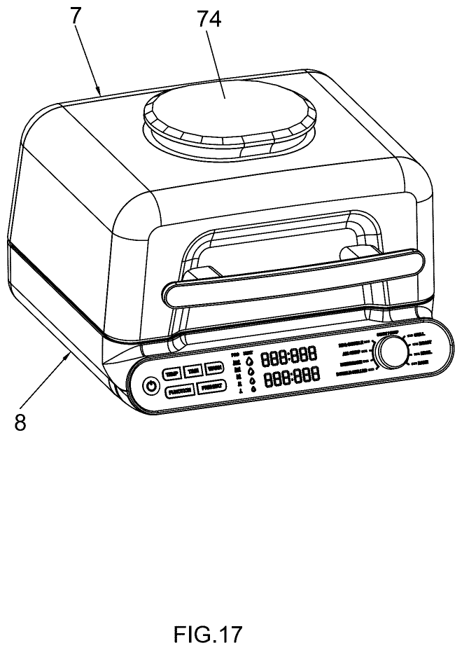

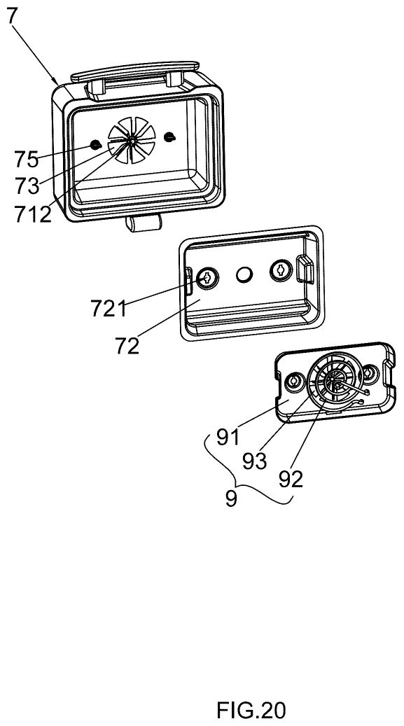

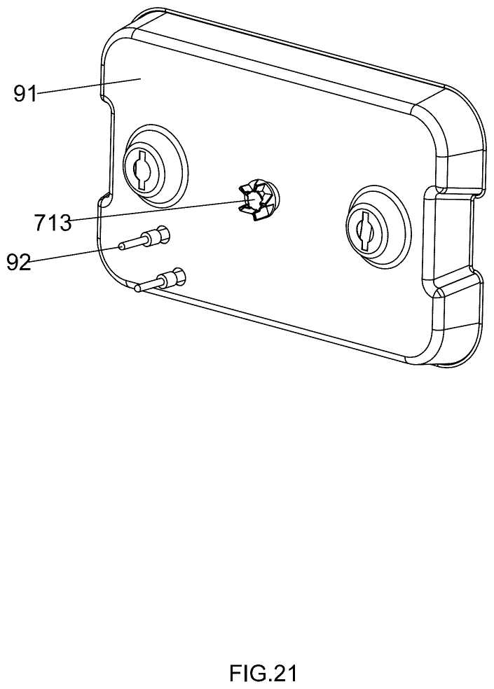

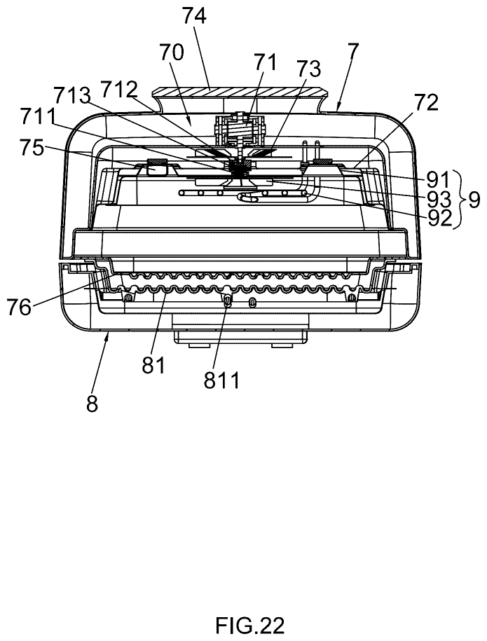

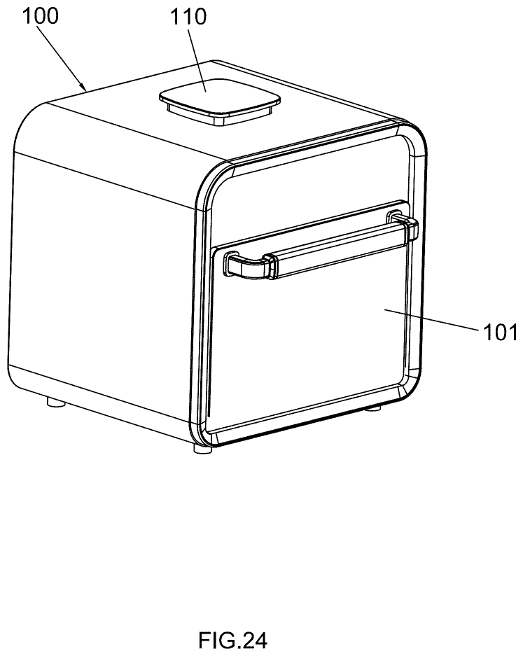

In FIGS. 1 to 6: 4—body; 41—cooking chamber; 42—window; 43—motor; 431—upper clutch; 432—lower clutch; 44—installation cavity; 441—overhaul cover; 45—tracks; 5—heating component; 51—heating tube; 511—L-shaped brackets; 52—uniform heating fan; 53—fixed cover; 54—cooling fan; 541—rotating shaft; 55—upper protective cover; 551—first hollow portions; 552—heat dissipation holes; 553—relief recess; 554—annular convex platform; 56—lower protective cover; 561—second hollow portions; 6—fryer assembly.
In FIGS. 7 to 16: 1—body; 11—cooking chamber; 12—installation window; 121—annular convex platform; 122—annular step surface; 123—limiting convex platforms; 124—heat dissipation holes; 13—rotating axis; 2—cover; 20—installation cavity; 21—motor; 22—overhaul cover; 23—first clutch; 24—second clutch; 25—limiting hooks; 26—sleeve; 27—first push rod; 28—second push rod; 3—heating component; 31—fixed cover; 32—heating tube; 33—uniform heating fan; 34—cooling fan; 35—rotating shaft; 36—protective cover; 361—exhaust holes; 362—water outlet holes.
In FIGS. 17 to 23: 7—upper pot body; 70—installation cavity; 71—motor; 711—rotating shaft; 712—first clutch; 713—second clutch; 72—protective cover; 721—strip-shaped notch; 73—cooling fan; 74—overhaul cover; 75—knob; 76—upper baking tray; 77—oil isolation net; 8—lower pot body; 81—lower baking tray; 811—lower heating component; 82—frying pot; 83—grill; 9—upper heating component; 91—fixed cover; 92—heating tube; 93—uniform heating fan.
In FIGS. 24 to 27: 100—box body; 101—box door; 102—baking cavity; 103—window; 104—support portion; 105—track; 106—motor; 107—first clutch; 108—second clutch; 109—mounting groove; 110—mounting bracket; 111—positioning posts; 112—elastic buckle; 200—heating component; 201—upper heating tube; 202—connecting brackets; 203—uniform heating fan; 204—fixed cover; 205—cooling fan; 206—rotating shaft; 207—protective cover; 208—hollow portions; 209—heat dissipation holes; 210—relief recess; 211—annular convex platform; 212—support cover; 213—hook; 300—lower heating tubes.

### DETAILED DESCRIPTION OF THE PREFERRED EMBODIMENT

The specific embodiments of the present invention will be described below with reference to the accompanying drawings. In order to fully understand the present invention, many details are described below, but it is apparent to those skilled in the art that the present invention can be implemented without these details.

FIGS. 1 to 6 are the relevant drawings of the first technical solution proposed by the present invention based on the overall invention concept of the detachable heating component, and the first technical solution involves to one embodiment (i.e., Embodiment 1) in total, and the structure details of the embodiment are described in detail below.

### Embodiment 1

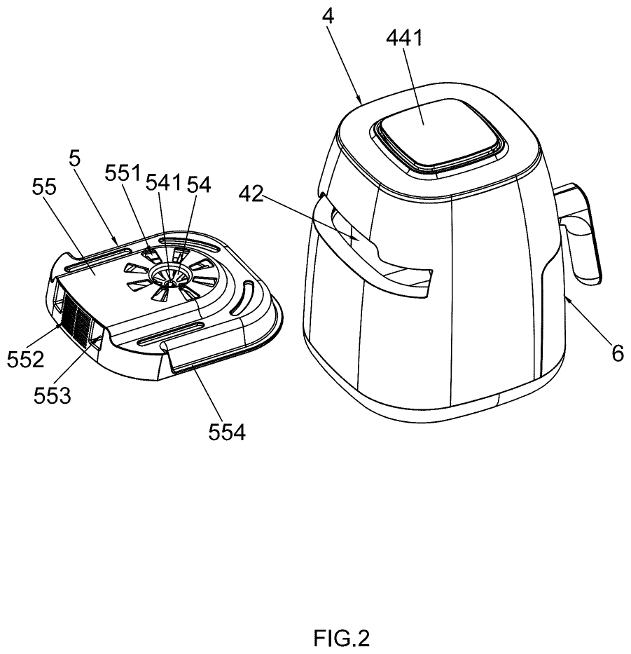

Referring to FIGS. 1 and 2, an air fryer includes a body 4 and a heating component 5 disposed thereon. The body 4 has a cooking chamber 41 disposed therein, and a window 42 disposed thereon and communicated with the cooking chamber 41. The heating component 5 is detachably installed in the window 42 and is used to heat the cooking chamber 41. The present invention provides the window 42 for installing the heating component 5 on the body 4. When the heating component 5 need cleaning, the heating component 5 is allowed to be directly disassembled from the window 42, and the operation is simple and convenient.

Referring to FIGS. 2, 5 and 6, specifically, the heating component 5 includes a heating tube 51, a uniform heating fan 52 and a fixed cover 53. The fixed cover 53 is detachably arranged in the window 42, and the heating tube 51 and the uniform heating fan 52 are disposed at the bottom of the fixed cover 53. The body 4 has a motor 43 disposed therein and connected with the uniform heat fan 52 in a transmission manner and a connecting component (not shown in the figure) that is electrically connected with the heating tube 51. The heating tube 51 is used to heat the inside of the cooking chamber 41, and the uniform heating fan 52 can improve the heat transfer efficiency and evenly transfer the heat of the heating tube 51 to all corners of the cooking chamber 41. The fixed cover 53 is capable of supporting the heating tube 51 and the uniform heating fan 52, so that the installation and disassembly of the heating component 5 are more convenient. Preferably, in this embodiment, the fixed cover 53 is designed as a reflective plate with a heat radiation reflective layer on the surface. The reflective plate can reflect the heat of the heating tube 51 into the cooking chamber 41, thereby improving the heating efficiency and ensuring uniform heating in the cooking chamber 41.

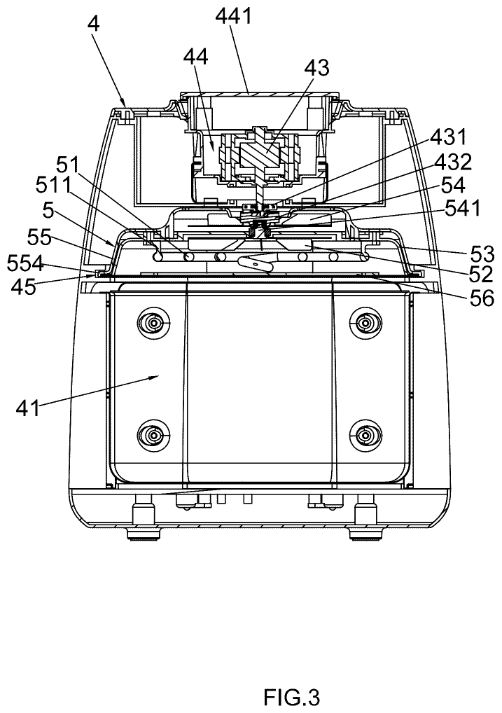

Referring to FIGS. 2 and 3, the heating component 5 has a cooling fan 54 arranged in the body for dissipating heat to the motor 43. The cooling fan 54 is arranged on the top of the fixed cover 53, and the cooling fan 54 and the uniform heating fan 52 are connected with the motor 43 through the same rotating shaft 541 in a transmission manner. Since the cooling fan 54 is arranged at the top of the fixed cover 53 and is coaxially connected with the uniform heating fan 52, when the fixed cover 53 is taken out, the cooling fan 54 is removed together with the uniform heating fan 52 and the heating tube 51, so that the cooling fan 54 can be cleaned. Due to the obstruction of the fixed cover 53, the oil stain entering the cooling fan 54 is relatively less, but there will still be oil stain accumulation after long-term use. Therefore, the cooling fan 54 and the heating component 5 are configured as an integrated detachable structure, and the oil stain cleaning is more comprehensive and thorough.

Referring to FIG. 2 to FIG. 6, in order to prevent the blades from being exposed and deformed by force, an upper protective cover 55 and a lower protective cover 56 are respectively arranged above and below the fixed cover 53. Specifically, a first cavity for installing the cooling fan 54 is provided between the upper protective cover 55 and the fixed cover 53, and a plurality of first hollow portions 551 are provided in the middle of the upper protective cover 55 and are connected to the first cavity. A second cavity for installing the heating tube 51 and the cooling fan 54 is provided between the lower protective cover 56 and the fixed cover 53, and a plurality of second hollow portions 561 are provided in the middle of the lower protective cover 56 and are connected to the second cavity. During cleaning, the cooling fan 54, the uniform heating fan 52 and the heating tube 51 can be cleaned by the first hollow portions 551 and the second hollow portions 561. The upper protective cover 55 has a plurality of heat dissipation holes 552 on a side wall thereof. The heat in the first cavity is discharged to the outside of the body 4 through the heat dissipation holes 552, thereby preventing heat from accumulating in the body 4 and effectively protecting the motor 43.

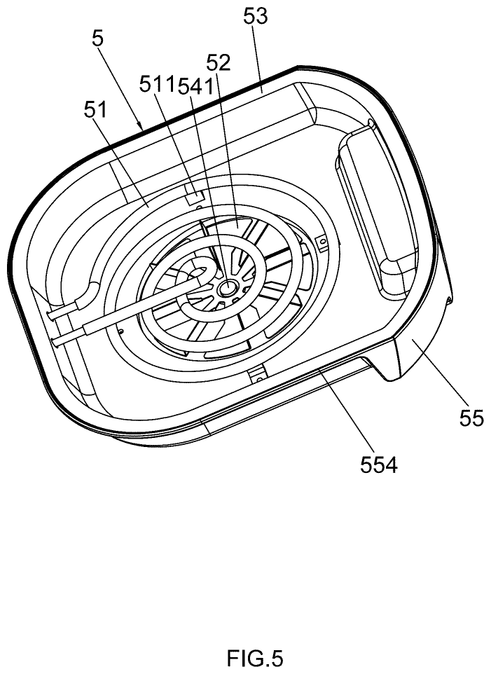

Referring to FIGS. 2 and 5, the heating tube 51 is installed on the fixed cover 53 through a plurality of L-shaped brackets 511 and is located below the uniform heating fan 52. The connecting component includes a socket and a power connector that match each other. The socket is arranged in the cooking chamber 41. The power connector is arranged at the end part of the heating tube 51 and extends to the outside of the fixed cover 53. When the fixed cover 53 is installed into the window 42, the power connector at the end part of the heating tube 51 is inserted into the socket, so that the circuit is turned on.

Referring to FIGS. 1 to 3, the body 4 has an independent installation cavity 44 arranged above the cooking chamber 41, and an overhaul cover 441 is configured to close the installation cavity 44. The motor 43 is installed in the installation cavity 44 through a mounting bracket, and an output shaft of the motor 43 is connected with the rotating shaft 541 through a clutch. Specifically, the clutch includes an upper clutch 431 and a lower clutch 432 that mesh with each other. The upper clutch 431 is arranged at the end of the output shaft of the motor 43, and the lower clutch 432 is arranged at the end of the rotating shaft 541. When the fixed cover 53 is installed in the window 42, the upper clutch 431 and the lower clutch 432 mesh with each other, and the motor 43 can drive the uniform heating fan 52 and the cooling fan 54 to rotate. Since the overhaul cover 441 is provided, each time the heating component 5 is installed and removed, the overhaul cover 441 can be opened to lift the motor 43 upward, so that the meshing or separation of the upper clutch 431 and the lower clutch 432 can be realized more conveniently. In other embodiments, the upper clutch 431 or the lower clutch 432 can also be configured as a structure that can float up and down and automatically reset, or other installation methods, so as to ensure that when the heating component 5 is installed and removed, the upper clutch 431 and the lower clutch 432 can realize automatic meshing or disengagement.

Referring to FIGS. 1, 2 and 4, preferably, the opening of the cooking chamber 41 faces the front side of the body 4, and a fryer assembly 6 is installed in the cooking chamber 41, and the window 42 is opened on the rear side of the body 4, so the appearance design of the front side of the body 4 will not be affected. The body 4 has tracks 45 arranged on both sides therein, and the upper protective cover 55 has an annular convex platform 554 that cooperates with the tracks 45 and is arranged on the outer peripheral edge thereof. By arranging mutually matched the rails 45 and the annular convex platform 554, the guiding and limiting functions can be achieved, thereby facilitating the fast installation of the fixed cover 53 into the window 42. It should be noted that in this embodiment, the window 42 is positioned at the rear side of the body 4, and the tracks 45 in the window 42 adopts parallel rails (that is, the tracks are extended and arranged along the width direction of the body 4), so the heating component can be installed by sliding horizontally. However, the scope of protection of the present invention is not limited to this, in other embodiments, the position of the window 42 may also be arranged in other positions such as the front side of the body 4 or the top of the body 4, and the installation method of the heating component can also adopt a vertical sliding installation or an oblique sliding installation and other methods, and those skilled in the art may make a reasonable design according to actual needs.

Referring to FIGS. 1 and 2, in order to facilitate the removal of the heating component 5, the upper protective cover 55 further has a relief recess 553 arranged on each of two sides of the heat dissipation holes 552.

FIGS. 7 to 16 are the relevant drawings of the second technical solution proposed by the present invention based on the overall invention concept of the detachable heating component, and the second technical solution involves the three embodiments in total (i.e., Embodiment 2 to Embodiment 4), and the structure details of these three embodiments are introduced in detail below, respectively.

### Embodiment 2

Referring to FIGS. 7 to 10, an air fryer includes a body 1, a cover 2 and a heating component 3 respectively arranged thereon. The body 1 has a cooking chamber 11 arranged therein, and an installation window 12 arranged thereon and communicated with the cooking chamber 11. The heating component 3 is detachably disposed in the installation window 12 and is used to heat the cooking chamber 11. The cover 2 and the body 1 are closed or separated from each other to close or open the installation window 12. When the heating component 3 needs to be cleaned, simply open the cover 2 and remove the heating component 3 as a whole from the installation window 12 for cleaning, making the operation simple and convenient. Since the heating component 3 is disposed in the installation window 12, the volume of the cover 2 is smaller, and the structural design is more exquisite and beautiful.

Referring to FIGS. 7 to 12, specifically, the heating component 3 includes a fixed cover 31, a heating tube 32 and a uniform heating fan 33 arranged at the bottom of the fixed cover 31. A connecting component electrically connected to the heating tube 32 is provided in the installation window 12 (not shown in the figure). The cover 2 has a motor 21 and a transmission component arranged therein for driving the uniform heating fan 33. The heating tube 32 is used to heat the inside of the cooking chamber 11, and the uniform heating fan 33 can improve the heat transfer efficiency and evenly transfer the heat of the heating tube 32 to all corners of the cooking chamber 11. The fixed cover 31 is capable of supporting the heating tube 32 and the uniform heating fan 33, so that the installation and disassembly of the heating component 3 are more convenient. Preferably, in this embodiment, the fixed cover 31 is designed as a reflective plate with a heat radiation reflective layer on the surface. The reflective plate can reflect the heat of the heating tube 32 into the cooking chamber 11, thereby further improving the heating efficiency and ensuring uniform heating in the cooking chamber 11.

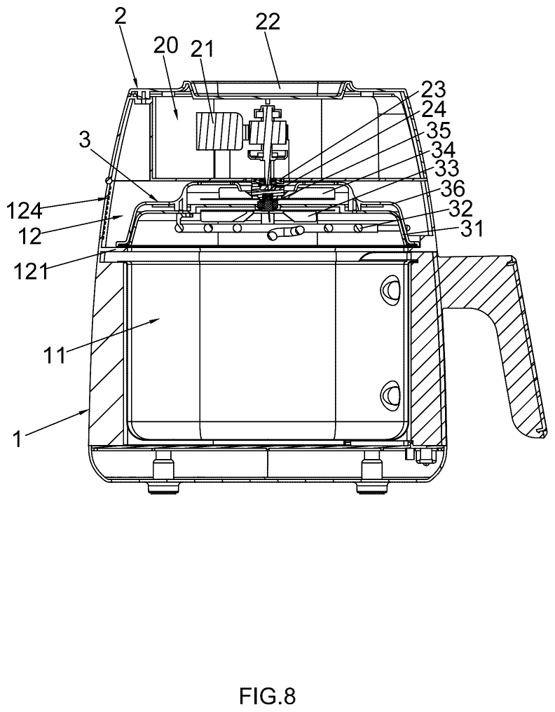

Referring to FIGS. 8 to 12, the air fryer further includes a cooling fan 34 arranged therein for dissipating heat to the motor 21. The cooling fan 34 is arranged on the top of the fixed cover 31, and the cooling fan 34 and the uniform heating fan 33 are connected with the transmission component through the same rotating shaft 541. Since the cooling fan 34 is arranged at the top of the fixed cover 31 and is coaxially connected with the uniform heating fan 33, when the fixed cover 31 is taken out, the cooling fan 34 is removed together with the uniform heating fan 33 and the heating tube 32, so that the cooling fan 34 can be cleaned. Due to the obstruction of the fixed cover 31, the oil stain entering the cooling fan 34 is relatively less, but there will still be oil stain accumulation after long-term use. Therefore, the cooling fan 34 and the heating component 3 are configured as an integrated detachable structure, and the oil stain cleaning is more comprehensive and thorough.

Referring to FIGS. 8 to 12, in order to prevent the blades from being exposed and deformed by force, a protective cover 36 is provided above the fixed cover 31. Specifically, a cavity for installing the cooling fan 34 is formed between the protective cover 36 and the fixed cover 31. Moreover, the protective cover 36 has a plurality of exhaust holes 361 and a plurality of water outlet holes 362 communicated with the cavity and respectively provided thereon. During operation, the wind from the cooling fan 34 is blown to the cover 2 through the exhaust holes 361, thereby dissipating heat to the motor 21. The body 1 has a plurality of heat dissipation holes 124 arranged on the side of the heating component 3, which is also beneficial to improving the heat dissipation effect. During cleaning, the cooling fan 34 is cleaned through the water outlet holes 362, and the cleaned water is discharged through the exhaust holes 361 and the water outlet holes 362 at the same time, thereby avoiding moisture residue. In addition, when cleaning, the entire heating component 3 can be directly placed in the dishwasher for cleaning, thereby reducing people's burden.

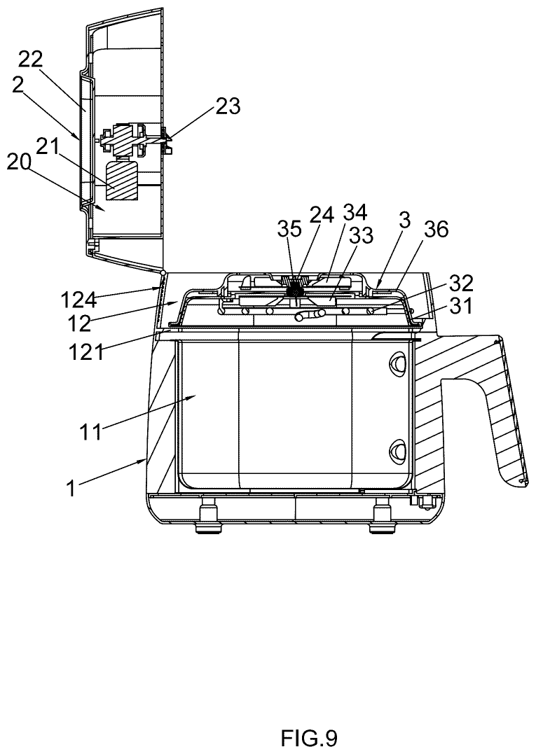

Referring to FIGS. 8 and 9, the cover 2 has an installation cavity 20 disposed therein. The motor 21 is arranged in the installation cavity 20 and is connected to the rotating shaft 35 through a transmission component. Such a structure can realize the hidden installation of the motor 21, thereby preventing potential safety hazards such as water intrusion into the motor 21 during cleaning. In order to prevent the heat of the motor 21 from accumulating in the installation cavity 20, a plurality of heat dissipation holes can be provided on the side wall of the cover 2. At the same time, in order to facilitate the maintenance and overhaul of the motor 21, in this embodiment, the cover 2 has an overhaul window on the top thereof, and an overhaul cover 22 is provided for closing the overhaul window.

Referring to FIGS. 8 to 12, the connecting component in this embodiment includes a socket and a power connector that match each other. The socket is arranged in the installation window 12, and the power connector is arranged at the end part of the heating tube 32. The transmission component includes a first transmission component and a second transmission component that are allowed to be separated or connected to each other. The first transmission component is provided on the output shaft of the motor, and the second transmission component is provided on the rotating shaft 35. As a preferred solution, the first transmission component and the second transmission component are respectively a first clutch 23 and a second clutch 24 that cooperate with each other, wherein the first clutch 23 is provided on the output shaft of the motor 21, and the second clutch 24 is provided on the rotating shaft 35. Therefore, when the heating component 3 is installed in the installation window 12, the heating tube 32 can be quickly connected with the power supply through the mutual connection of the socket and the power connector, and the uniform heating fan 33 and the cooling fan 34 can also be quickly connected with the motor 21 through the mutual engagement of the first clutch 23 and the second clutch 24, thereby realizing quick docking of the heating component 3 and the cover 2, thus improving the disassembly and assembly efficiency.

Referring to FIGS. 7 to 9, the installation window 12 has a support portion disposed therein, and the heating component 3 is placed above the support portion. As a preferred solution: the support portion is an annular convex platform 121 provided on the inner wall of the installation window 12, and the heating component 3 is placed above the annular convex platform 121. This design can reduce unnecessary installation components and disassembly processes, so that the heating component 3 can be quickly taken out and put in.

Referring to FIGS. 7 to 10, the connection method between the cover 2 and the body 1 includes but is not limited to a flip hinge connection, a snap connection, a rotating cover connection or a horizontal sliding connection. Specifically, the flip hinge connection means that the cover 2 is turnably installed on the body 1 through a hinge, the snap connection means that the cover 2 is detachably installed on the body 1 through a buckle component, the rotating cover connection means that the cover 2 is installed on the body 1 through a threaded connection or other rotating methods, and the horizontal sliding connection means that the cover 2 is capable of being horizontally slidably installed on the body 1 through a slide rail component. The above connection methods can realize the mutual covering or separation of the cover 2 and the body 1, thereby achieving the purpose of closing or opening the installation window 12, so that in practical application, reasonable selection and design can be carried out according to specific needs. As a preferred solution: in this embodiment, the cover 2 is connected to the body 1 in a flip hinge connection manner. Specifically, one side of the cover 2 is vertically flippable disposed on the body 1 through a hinge, and the other side of the cover 2 is interconnected to the body 1 through a fastener (not shown in the figure).

### Embodiment 3

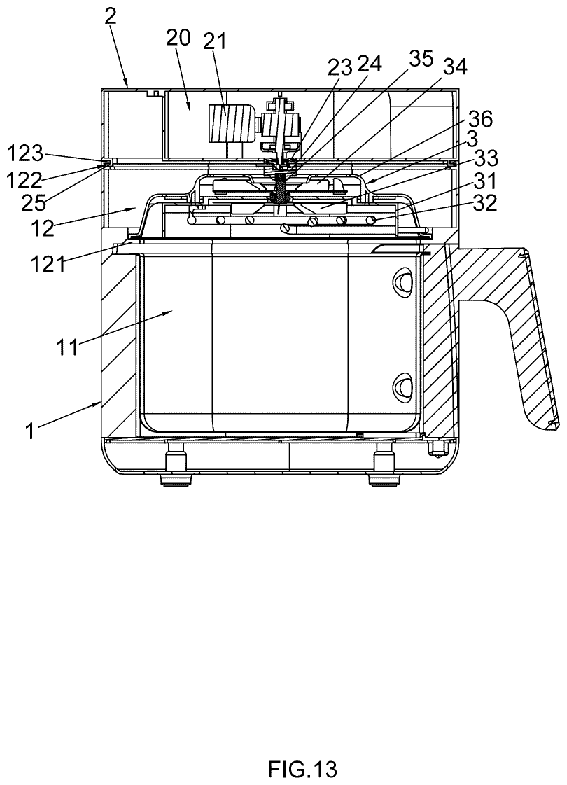

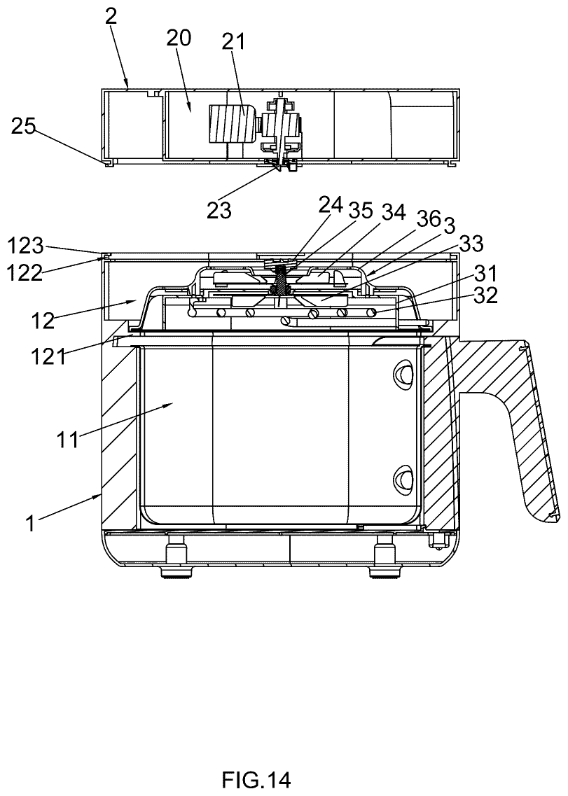

Referring to FIGS. 13 and 14, what is different from Embodiment 2 is that the connection method between the cover 2 and the body 1 in this embodiment is a rotating cover connection. Specifically, the body 1 has an annular step surface 122 provided on the inner wall of the installation window 12 and a plurality of limiting convex platforms 123 arranged at intervals with each other. The cover 2 has a plurality of limiting hooks 25 provided on a bottom edge thereof. When closing the cover, first rotate the cover 2 to a certain angle so that the limiting hooks 25 and the limiting convex platforms 123 are misaligned with each other, then place the cover 2 on the annular step surface 122, and then rotate the cover 2 to the certain angle, so that the limiting hook 25 and the limiting convex platforms 123 are against about each other to achieve locking. In order to ensure that the connection mode can be smoothly implemented, the structure of the limiting convex platforms 123 and the limiting hooks 25 should be reasonably designed in combination with the external shape structure of the cover 2 during the design, so as to prevent the situation that the cover 2 cannot rotate compared with the body 1. Of course, the cover 2 can also be directly designed as a circular structure that facilitates rotation around a central axis thereof.

### Embodiment 4

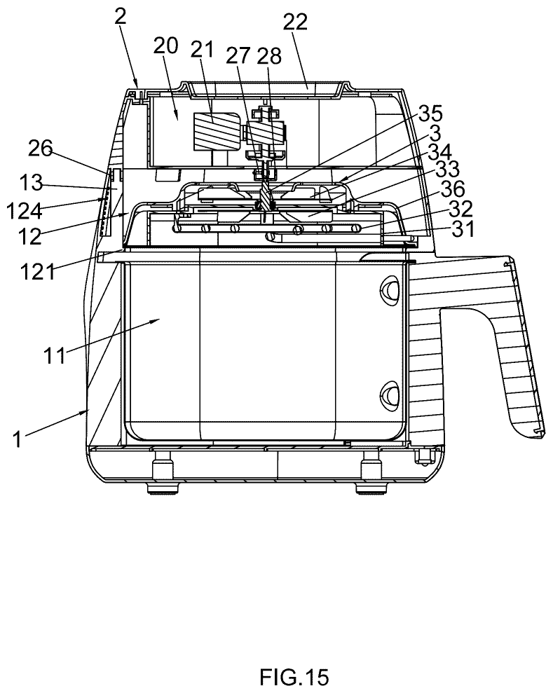

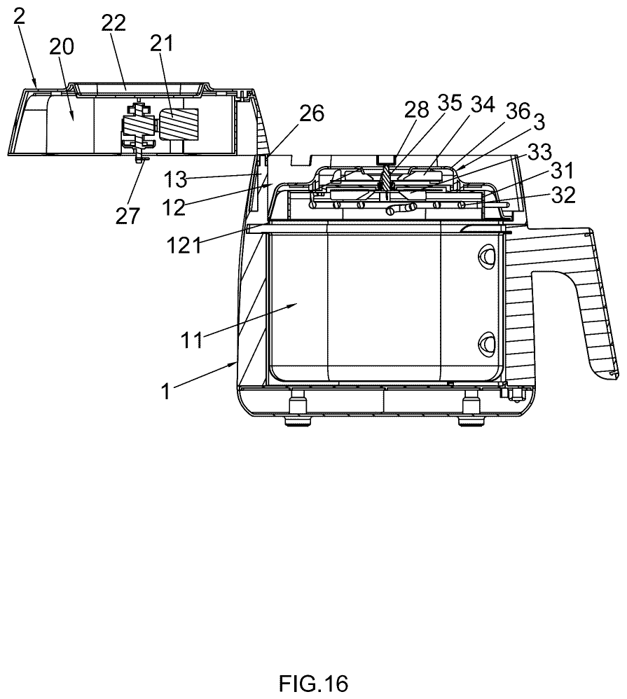

Referring to FIGS. 15 and 16, what is different from Embodiment 2 is that the connection method between the cover 2 and the body 1 in this embodiment is a rotating cover connection. Specifically, the body 1 has a rotating axis 13 extending along the vertical direction and located on the side of the installation window 12. The cover 2 has a sleeve 26 that cooperates with the rotating axis 13 and is provided on the side wall thereof. The cover 2 can rotate horizontally around the rotating axis 13 through the sleeve 26, thereby opening or closing the installation window 12.

Referring to FIGS. 15 and 16, due to the different connection methods between the cover 2 and the body 1, the structure of the transmission component is also adjusted accordingly in the present embodiment: the first transmission component and the second transmission component are respectively the first push rod 27 and the second push rod 28 that are abutted against each other. Specifically, the first push rod 27 is a straight structure and is arranged vertically on the output shaft of the motor 21, and the second push rod 28 is a U-shaped structure with an upward opening, and is disposed at the end of the rotating shaft 35. When the cover 2 is closed, the first push rod 27 and one side wall of the two sides of the first push rod 28 are against each other, and when the motor 21 is working, the first push rod 27 rotates with the output shaft of the motor 21, thereby driving the second push rod 28 and the rotating shaft 35 to rotate, thus driving the uniform heating fan 33 and the cooling fan 34 to rotate.

In addition to the two transmission components described in Embodiment 2 and Embodiment 3, in other embodiments, other structures, such as a magnetic attraction type, can also be used to design the transmission component. For example: the first transmission component is the first magnetic component, and the second transmission component is the second magnetic component, one of the first magnetic component and the second magnetic component is a magnet (or electromagnet), and the other is a metal that can be attracted by the magnet (or electromagnet), or both the first magnetic component and the second magnetic component are magnets (or electromagnets) that can attract each other. During operation, the polarity of the first magnetic component changes through motor rotation and attracts each other to the second magnetic component, thereby driving the rotating shaft 35 to rotate.

FIGS. 17 to 23 are the relevant drawings of the thirdly technical solution proposed by the present invention based on the overall invention concept of the detachable heating component, and the thirdly technical solution involves to one embodiment (i.e., Embodiment 5) in total, and the structure details of the embodiment are described in detail below.

### Embodiment 5

Referring to FIGS. 17 to 20, an air fryer includes an upper pot body 7, a lower pot body 8, an upper heating component 9, and a cooking container, wherein the upper pot body 7 and the lower pot body 8 are covered or separated from each other, thereby forming a cooking chamber with different cooking functions, wherein the cooking container is installed in the cooking chamber and used to hold ingredients, wherein the upper heating component 9 is detachably arranged in the upper pot body 7 and used to heat the cooking chamber. Since the whole upper heating component 9 adopts a modular and detachable structure, when the upper heating component 9 needs to be cleaned, the upper heating component 9 can be directly disassembled from the upper pot body 7, making the operation simple and convenient.

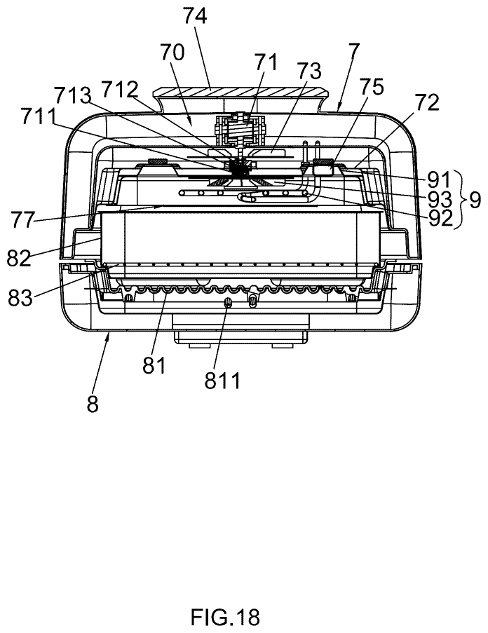

Referring to FIGS. 18 to 21, specifically, the upper heating component 9 includes a fixed cover 91, a heating tube 92, and a uniform heating fan 93, wherein one side of the fixed cover 91 is detachably arranged on the upper pot body 7, and the other side of the fixed cover 91 is provided with the heating tube 92 and the uniform heating fan 93, wherein the upper pot body 7 has a connecting component (not shown in the figure) disposed therein and electrically connected to the heating tube 92, and a motor 71 and a transmission component disposed therein for driving the uniform heating fan 93. The heating tube 92 is used to heat the inside of the cooking chamber, and the uniform heating fan 93 can improve the heat transfer efficiency and evenly transfer the heat of the heating tube 92 to all corners of the cooking chamber. The fixed cover 91 is capable of supporting the heating tube 92 and the uniform heating fan 93, so that the installation and disassembly of the upper heating component 9 are more convenient. Preferably, in this embodiment, the fixed cover 91 is designed as a reflective plate with a heat radiation reflective layer on the surface. The reflective plate can reflect the heat of the heating tube 92 into the cooking chamber, thereby further improving the heating efficiency and ensuring uniform heating in the cooking chamber.

Referring to FIGS. 18 to 21, more specifically, the connecting component includes a socket and a power connector that match each other. The socket is arranged in the upper pot body 7, and the power connector is arranged at the end part of the heating tube 92. The transmission component includes a rotating shaft 711 and a first transmission component and a second transmission component that are allowed to be separated or connected to each other. The uniform heating fan 93 is arranged on the fixed cover 91 through the rotating shaft 711, the first transmission component is arranged on the output shaft of the motor 71, and the second transmission component is arranged on the rotating shaft 711. As a preferred solution, in this embodiment, the first transmission component and the second transmission component are respectively the first clutch 712 and the second clutch 713 that cooperate with each other. Therefore, when the upper heating component 9 is installed in the upper pot body 7, the heating tube 92 can be quickly connected to the power supply through the mutual connection of the socket and the power connector, and the uniform heating fan 93 can also be quickly connected to the motor 71 through the mutual engagement of the first clutch 712 and the second clutch 713, thereby realizing quick docking of the upper heating component 9 and the upper pot body 7, thus improving the disassembly and assembly efficiency.

Referring to FIGS. 18 to 21, in other embodiments, the first transmission component and the second transmission component can also adopt a push rod structure or a magnetic structure. For example: when the push rod structure is adopted, the first transmission component and the second transmission component are respectively the first push rod and the second push rod that can abut against each other. When the motor 71 is working, the first push rod rotates with the output shaft of the motor, thereby driving the second push rod and the rotating shaft 711 to rotate, thereby driving the uniform heating fan 93 to rotate. When the magnetic structure is adopted, the first transmission component and the second transmission component are respectively the first magnetic component and the second magnetic component that can be attracted to each other, and one of the first magnetic component and the second magnetic component is a magnet (or electromagnet), the other is a metal that can be attracted by a magnet (or electromagnet), or the first magnetic component and the second magnetic component are both magnets (or electromagnets) that can be attracted to each other. During operation, the rotation of the motor causes the polarity of the first magnetic component to alter and the second magnetic component to attract each other, thereby driving the uniform heating fan 93 to rotate.

Referring to FIGS. 18 to 21, the air fryer also includes a protective cover 72 and a cooling fan 73, wherein the protective cover 72 is disposed between the upper pot body 7 and the fixed cover 91, wherein the cooling fan 73 is disposed between the upper pot body 7 and the protective cover 72 and is connected with the output shaft of the motor 71. The cooling fan 73 is capable of blowing away the heat of the motor 71 in time to prevent the service life of the motor 71 from being affected by excessive temperature. In practical applications, the protective cover 72 can be configured as detachable or non-detachable according to the cleaning needs of the cooling fan 73. As a preferred solution: in the implementation, the protective cover 72 is detachably arranged between the upper pot body 7 and the fixed cover 91. Due to the protection of the protective cover 72, the cooling fan 73 will not be exposed after the upper heating component 9 is disassembled. Therefore, the blades can be prevented from being exposed and deformed by force. At the same time, due to the obstruction of the protective cover 72, oil stains are less likely to enter the cooling fan 73, so the cooling fan 73 generally does not require regular cleaning. However, occasional cleaning or maintenance can also be achieved by disassembling the protective cover 72, making the structure more user-friendly.

Referring to FIGS. 18 to 21, the upper pot body 7 has an installation cavity 70, the motor 71 is installed in the installation cavity 70, and the output shaft of the motor 71 is provided with a cooling fan 73 and a first clutch 712. Such a structure can realize the concealed installation of the motor 71, thereby preventing potential safety hazards such as water intrusion into the motor 71 during cleaning. In order to prevent the heat of the motor 71 from accumulating in the installation cavity 70, the upper pot body 7 has a plurality of exhaust holes (not shown in the figure) provided thereon. At the same time, in order to facilitate the maintenance and overhaul of the motor 71, in the embodiment, the upper pot body 7 has an overhaul window arranged on the top thereof, and an overhaul cover 74 is provided thereon for closing the overhaul window.

Referring to FIGS. 18 to 20, as a specific installation method, two sides of the upper pot body 7 each have a knob 75 with a limiting convex platform, wherein the protective cover 72 and the fixed cover 91 both have a strip-shaped notch 721 that matches the knob 75. The knob 75 is rotated to be aligned with the strip-shaped notch 721, and the realization can be unlocked, so that the protective cover 72 and the fixed cover 91 are removed from the limiting convex platform. The knob 75 is rotated to be misaligned with the strip-shaped notch 721, and the locking can be realized, so that the protective cover 72 and the fixed cover 91 are fixed on the limiting convex platform.

Referring to FIG. 18, the air fryer further includes an oil isolation net 77, which is detachably and washably arranged on the upper pot body 7 and is positioned below the upper heating component 9. The oil isolation net 77 has an oil stain blocking effect, reducing the amount of oil stain on the upper heating component 9, thereby reducing the frequency and difficulty of cleaning the upper heating component 9. When the upper heating component 9 needs to be cleaned, the oil isolation net 77 and the entire upper heating component 9 can be placed in a dishwasher for cleaning, thereby reducing people's burden.

Referring to FIGS. 18, 19 and 23, the lower pot body 8 has a lower baking tray 81 detachably disposed therein, which has a lower heating component 811 at the bottom thereof. When the upper pot body 7 and the lower pot body 8 cover each other, the upper heating component 9 cooks the food in the cooking chamber alone, or the upper heating component 9 and the lower heating component 811 cooperate with each other to cook the food in the cooking chamber. When the upper pot body 7 and the lower pot body 8 are separated from each other, the lower heating assembly 811 cooks the food in the cooking chamber alone. As a preferred solution, the lower heating component 811 is also selected with a heating tube. Specifically, when the upper pot body 7 and the lower pot body 8 are covered with each other, an air frying chamber with air frying function is capable of being formed between the two. At this time, the upper heating component 9 is allowed to be used alone to heat the air frying chamber, or the lower heating component 811 is allowed to be turned on at the same time to heat the air frying chamber. In addition, a cooking chamber with pan-fry and broil, steam or other function other than air frying is allowed to be formed between the upper pot body 7 and the lower pot body 8. At this time, the lower heating component 811 is allowed to be used alone to heat the cooking chamber, or the upper heating component 9 is allowed to be turned on at the same time to heat the cooking chamber. When the upper pot body 7 and the lower pot body 8 are separated from each other, the lower pot body 8 is also allowed to independently form a cooking chamber with functions of pan-fry and broil, steam or other functions in addition to air frying. At this time, the upper heating component 9 does not work, and the lower heating component 811 heats the cooking chamber separately. It can be seen that the air fryer provided in the embodiment allows different cooking functions to be combined and set according to the mutually covering or mutually separated states of the upper pot body 7 and the lower pot body 8, and allows setting corresponding control programs according to different cooking functions, thereby enabling the upper heating component 9 and the lower heating component 811 to be used alone or in combination, thereby realizing one machine with multiple uses and meeting the diverse needs of customers.

Referring to FIGS. 18, 19 and 23, the cooking container is a frying pot 82 or an upper baking tray 76, wherein the frying pot 82 is placed above the lower baking tray 81, and the upper baking tray 76 is detachably arranged on the upper pot body 7 and is positioned below the upper heating component 9. Specifically, when the cooking chamber is used as an air frying chamber or as a cooking chamber with a steaming function, the frying pot 82 is capable of being selected as the cooking container, and other components, such as the grill 83, are also capable of being placed in the frying pot 82. When the cooking chamber is used as a cooking chamber with a pan-fry and broil function, the frying pot 82 is capable of being removed, and the upper baking tray 76 is installed, so that the upper baking tray 76 and the lower baking tray 81 cooperate with each other to form a pan-fry and broil cavity, thereby achieving the pan-fry and broil effect of the frying and baking device. Of course, in addition to the two cooking containers and usage methods introduced in the embodiment, in practical applications, other cooking containers can also be selected to be used alone or in combination according to the cooking function, thereby realizing the multi-functional expansion of the air fryer.

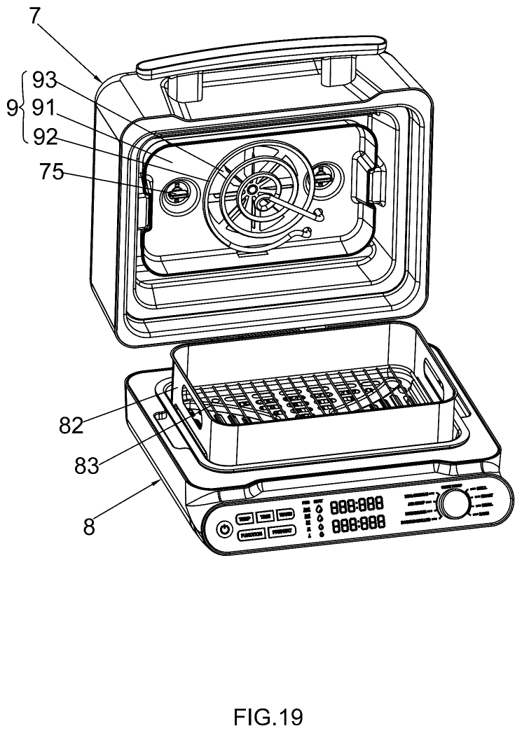

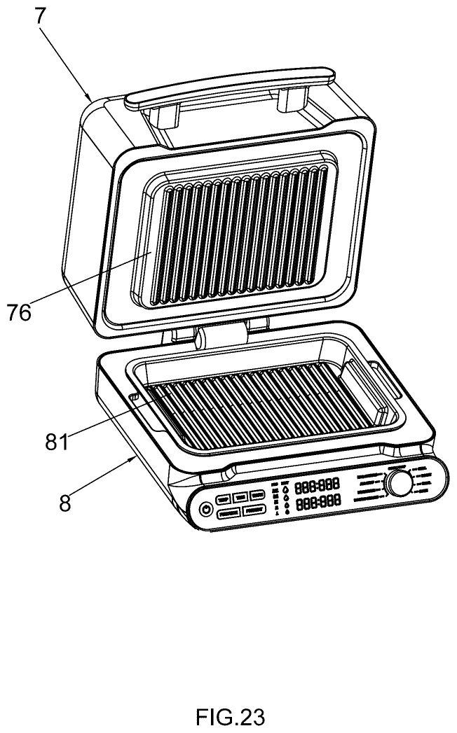

Referring to FIGS. 19 and 23, the connection methods of the upper pot body 7 and the lower pot body 8 include, but are not limited to, a flip hinge connection, a snap connection, a rotating cover connection, a horizontal sliding connection, or a vertical lifting connection. Specifically, the flip hinge connection means that the upper pot body 7 is turnably arranged on the lower pot body 8 through a hinge, the snap connection means that the upper pot body 7 is detachably arranged on the lower pot body 8 through a buckle component, the rotating cover connection means that the upper pot body 7 is installed on the lower pot body 8 through threaded connection or other rotation methods, the horizontal sliding connection means that the upper pot body 7 is capable of being horizontally slidably arranged on the lower pot body 8 through a slide rail component, and the vertical lifting connection means that the upper pot body 71 is capable of being vertically lifted on the lower pot body 8 through a lifting mechanism. The above several connection methods can realize the mutual covering or mutual separation of the upper pot body 7 and the lower pot body 8, so in practical applications, reasonable selection and design can be carried out according to specific needs. As a preferred solution: in the implementation, the upper pot body 7 is reversibly disposed on the lower pot body 8 through a hinge.

FIGS. 24 to 27 are the relevant drawings of the fourthly technical solution proposed by the present invention based on the overall invention concept of the detachable heating component, and the fourthly technical solution involves to one embodiment (i.e., Embodiment 6) in total, and the structure details of the embodiment are described in detail below.

### Embodiment 6

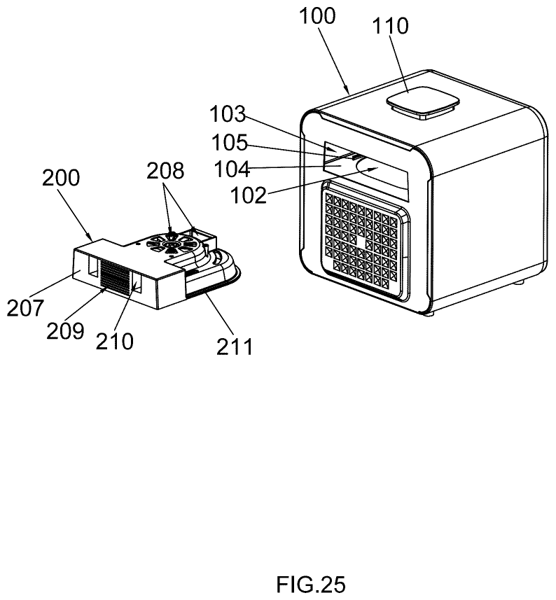

Referring to FIGS. 24 and 25, an oven with a detachable heating component, includes a box body 100, a box door 101, and a heating component, wherein the box body 100 has a baking cavity 102 and the box door 101 used to close the baking cavity 102, and the box body 100 has a window 103 disposed thereon and communicated with the baking cavity 102, wherein the heating component includes a heating component 200, the heating component 200 is detachably disposed in the window 103 and is used to heat the baking cavity 102. The present invention has the window 103 provided on the box body 100 for installing the heating component 200, and when cleaning is required, the heating component 200 is allowed to be directly disassembled from the window 103, which is simple and convenient to operate.

Referring to FIGS. 25 to 27, specifically, the heating component 200 includes an upper heating tube 201, a uniform heating fan 203, and a fixed cover 204, wherein the fixed cover 204 is detachably disposed in the window 103, and the upper heating tube 201 and the uniform heating fan 203 are provided at the bottom of the fixed cover 204, wherein the window 103 has a connecting component (not shown in the figure) disposed therein and electrically connected with the upper heating tube 201, and a motor 106 and a transmission component disposed therein and connected with the uniform heating fan 203 in a transmission manner. The upper heating tube 201 is used to heat the inside of the baking cavity 102, and the uniform heating fan 203 can improve the heat transfer efficiency and evenly transfer the heat of the upper heating tube 201 to all corners of the baking cavity 102. The fixed cover 204 is capable of supporting the upper heating tube 201 and the uniform heating fan 203, so that the installation and disassembly of the heating component 200 are more convenient. Preferably, in this embodiment, the fixed cover 204 is designed as a reflective plate with a heat radiation reflective layer on the surface. The reflective plate can reflect the heat of the upper heating tube 201 into the baking cavity 102, thereby improving the heating efficiency and ensuring uniform heating in the baking cavity 102.

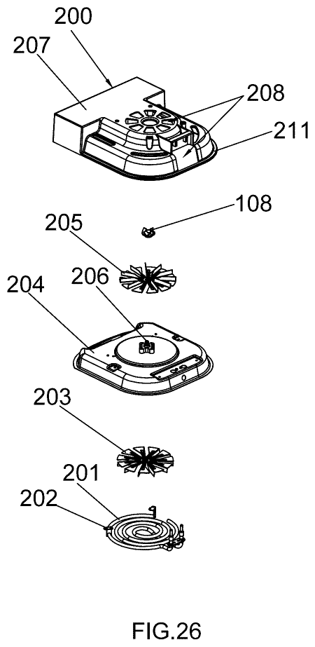

Referring to FIGS. 25 and 26, the oven further includes a protective cover 207 and a cooling fan 205, wherein the cooling fan 205 is used to dissipate heat from the motor 106, and the protective cover 207 is used to prevent the blades of the cooling fan 205 from being exposed and deformed by force. In practical applications, the installation mode of the protective cover 207 and the cooling fan 205 includes the following two: the first is that the protective cover 207 and the cooling fan 205 are configured as a whole with the heating component 200 to facilitate disassembly and cleaning, that is, the protective cover 207 is disposed above the fixed cover 204, and the cooling fan 205 is disposed between the protective cover 207 and the fixed cover 204, and is connected with the rotating shaft 206 of the uniform heating fan 203; the second is that the protective cover 207 and the cooling fan 205 are arranged at the bottom of the motor 106, and are not configured as a whole with the heating component 200, thereby fully simplifying the structure of the heating component 200, that is, the protective cover 207 is provided at the bottom of the motor 106, and the cooling fan 205 is provided between the motor 106 and the fixed cover 204, and is connected to the output shaft of the motor 106.

Referring to FIGS. 25 and 26, the embodiment prefers the first installation method to install the protective cover 207 and the cooling fan 205. Specifically, the cooling fan 205 is disposed on the top of the fixed cover 204, and the cooling fan 205 and the uniform heating fan 203 are connected with the transmission component through the same rotating shaft 206. Since the cooling fan 205 is arranged at the top of the fixed cover 204 and is coaxially connected with the uniform heating fan 203, when the fixed cover 204 is taken out, the cooling fan 205 will be removed along with the uniform heating fan 203 and the upper heating tube 201, so that the cooling fan 205 is capable of being cleaned. Due to the obstruction of the fixed cover 204, the oil stain entering the cooling fan 205 is relatively less, but there will still be oil stain accumulation after long-term use. Therefore, the cooling fan 205 and the heating component 200 are configured as an integrated detachable structure, and the oil stain cleaning is more comprehensive and thorough. A protective cover 207 is provided above the fixed cover 204, and a cavity for installing the cooling fan 205 is formed between the protective cover 207 and the fixed cover 204. Moreover, a plurality of hollow portions 208 and a plurality of heat dissipation holes 209 are provided in the middle of the protective cover 207 and are connected with the cavity. During cleaning, the cooling fan 205 in the cavity can be cleaned through the hollow portions 208. The plurality of heat dissipation holes 209 are provided on the side wall of the protective cover 207. The heat in the cavity is discharged to the outside of the box body 100 through the heat dissipation holes 209, thereby preventing heat from accumulating in the box body 100 and effectively protecting the motor 106. In order to facilitate the removal of the heating component 200, the protective cover 207 further has a relief recess 210 arranged on each of two sides of the heat dissipation holes 209.

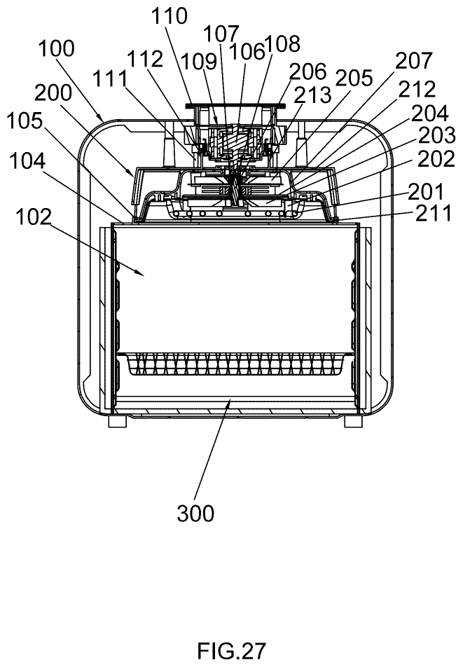

Referring to FIGS. 25 and 27, the upper heating tube 201 is installed at the bottom of the fixed cover 204 through a plurality of connecting brackets 202, and is arranged below the uniform heating fan 203. The connecting component includes a socket and a power connector that match each other. The socket is arranged in the baking cavity 102, and the power connector is arranged at the end part of the upper heating tube 201 and extends to the outside of the protective cover 207. When the heating component 200 is installed in the window 103, the power connector at the end part of the upper heating tube 201 is inserted into the socket, so that the circuit is turned on.

Referring to FIGS. 24 to 27, the box body 100 has a mounting groove 109 arranged on the top thereof and connected with the window 103, wherein the motor 106 is detachably arranged in the mounting groove 109 through a mounting bracket 110, and is connected with the rotating shaft 206 through a transmission component. The transmission component includes a first transmission component and a second transmission component that are allowed to be separated or connected to each other. The first transmission component is provided on the output shaft of the motor 106, and the second transmission component is provided on the rotating shaft 206. As a preferred solution, the first transmission component and the second transmission component are respectively a first clutch 107 and a second clutch 108 that cooperate with each other, wherein the first clutch 107 is provided on the output shaft of the motor 106, and the second clutch 108 is provided on the rotating shaft 206. Therefore, when the heating component 200 is installed in the window 103, the motor 106 is allowed to be lifted upward through the mounting bracket 110, so that the first clutch 107 and the second clutch 108 engage with each other, thereby achieving quick docking and improving the disassembly and assembly efficiency.

Referring to FIG. 27, the oven further includes a support cover 212 fixed at the bottom of the mounting groove 109, wherein the mounting bracket 110 has a plurality of positioning posts 111 arranged at the bottom thereof, wherein the support cover 212 has positioning holes arranged thereof for inserting the positioning posts 111, wherein the mutual cooperation between the positioning posts 111 and the positioning holes allows a positioning and guiding function to ensure that the motor 106 is accurately installed in the mounting groove 109, thereby ensuring that the first clutch 107 and the second clutch 108 are docked accurately and firmly. In order to ensure the cooling effect of the cooling fan 205 on the motor 106, the support cover 212 also has a hollow portions arranged thereon and connected with the cavity. Therefore, the airflow generated by the cooling fan 205 in the cavity can flow to the motor 106 through the hollow portions of the protective cover 207 and the support cover 212, thereby dissipating heat to the motor. In addition, the support cover 212 is also allowed to have the effect of shielding the motor 106 and the mounting bracket 110, preventing the user from seeing the internal components through the window 103 and affecting the visual effect.

Referring to FIG. 27, in order to further improve the connection stability of the first clutch 107 and the second clutch 108, the mounting bracket 110 has an elastic buckle 112 arranged on each of two sides thereof, and the support cover 212 has a hook 213 matched to each of the elastic buckles 112 disposed thereon. When the heating component 200 needs to be disassembled, the top of the mounting bracket 110 is pressed, that is, the elastic buckles 112 and the hooks 213 are allowed to be separated from each other, so that the motor 106 is conveniently lifted upwards, and the heating component 200 is smoothly pulled out. When the heating component 200 is installed, the top of the mounting bracket 110 is pressed, that is, the elastic buckles 112 and the hooks 213 are allowed to hook each other, so that the motor is installed in place, so that the first clutch 107 and the second clutch 108 are firmly engaged together, and the structure is ensured to be more stable and reliable.

Referring to FIG. 27, the oven further includes a plurality of lower heating tubes 300 arranged side by side in the baking cavity 102, wherein a gap between the lower heating tubes 300 and the bottom of the baking cavity 102. Due to the gap between the lower heating tubes 300 and the bottom of the baking cavity 102, cleaning is allowed without disassembly. In practical applications, corresponding control programs are allowed to be set according to different cooking functions of the oven, thereby controlling the heating component 200 and the lower heating tubes 300 to work alone or at the same time, thus realizing one machine with multiple functions and meeting the diverse needs of customers.

Referring to FIGS. 24 to 27, preferably, the opening of the baking cavity 102 faces the front side of the box body 100, and the baking cavity 102 has a baking pan and other appliances installed therein, wherein the window 103 is opened on the rear side of the box body 100, so the appearance design of the front side of the box body 100 will not be affected. The window 103 has a support portion 104 arranged therein, and the support portion 104 has a track 105 arranged on the edge thereof. The heating component 200 is disposed in the window 103 along the track 105 in a drawable manner and is arranged above the support portion 104. Specifically, the outer peripheral edges of the fixed cover 204 and the protective cover 207 each have an annular convex platform 211 arranged thereon and matches with the track 105. By arranging the track 105 and the annular convex platform 211 that cooperate with each other, the guiding and limiting effects are allowed to be realized, so that the fixed cover 204 is quickly installed into the window 103. In other embodiments, the position of the window 103 is also allowed to be arranged in other positions, such as the front side of the box body 100 or the top of the box body 100. Moreover, the mounting mode of the heating component 200 also allows the vertical sliding installation or oblique sliding installation and other methods, and those skilled in the art can make a reasonable design according to the actual needs.

The above are only the specific embodiments of the present invention, but the design concept of the present invention is not limited thereto, and any non-substantial modification of the present invention by using this concept shall be an act of infringing the scope of protection of the present invention.

What is claimed is:

1. An air fryer, comprising a body and a heating component, wherein the body has a cooking chamber arranged therein, and a window arranged thereon and communicated with the cooking chamber, wherein the heating component is detachably arranged in the window and is used to heat the cooking chamber.

2. The air fryer, as recited in claim 1, wherein the heating component comprises a heating tube, a uniform heating fan, and a fixed cover, wherein the fixed cover is detachably arranged in the window, and the heating tube and the uniform heating fan are arranged at a bottom of the fixed cover, wherein the body has a motor arranged therein and connected with the uniform heating fan in a transmission manner and a connecting component arranged thereon and electrically connected with the heating tube.

3. The air fryer, as recited in claim 2, wherein the heating component further comprises a cooling fan, wherein the cooling fan is arranged at a top of the fixed cover, and the cooling fan and the uniform heating fan are connected with the motor through a same rotating shaft in a transmission manner.

4. The air fryer, as recited in claim 2, wherein the heating component further comprises an upper protective cover arranged above the fixed cover, and a first cavity for installing the cooling fan arranged between the upper protective cover and the fixed cover, wherein the upper protective cover has a plurality of first hollow portions arranged in the middle thereof and connected with the first cavity and a plurality of heat dissipation holes arranged on a side wall thereof.

5. The air fryer, as recited in claim 2, wherein the heating component further comprises a lower protective cover arranged below the fixed cover, and a second cavity for installing the heating tube and the cooling fan arranged between the lower protective cover and the fixed cover, wherein the lower protective cover has a plurality of second hollow portions arranged thereon and connected with the second cavity.

6. The air fryer, as recited in claim 2, wherein the heating tube is installed on the fixed cover through a plurality of L-shaped brackets and is located below the uniform heating fan.

7. The air fryer, as recited in claim 2, wherein the connecting component comprises a socket and a power connector that match each other, wherein the socket is arranged in the cooking chamber, wherein the power connector arranged at an end part of the heating tube and extends to the outside of the fixed cover.

8. The air fryer, as recited in claim 4, wherein the body has a track arranged on each of two sides therein, wherein the upper protective cover has an annular convex platform that cooperates with the track and is arranged on an outer peripheral edge thereof.

9. The air fryer, as recited in claim 3, wherein the body has an independent installation cavity arranged above the cooking chamber, and an overhaul cover arranged to close and fit with the installation cavity, wherein the motor is installed in the installation cavity through a mounting bracket, and an output shaft of the motor is connected with the rotating shaft through a clutch.

10. The air fryer, as recited in claim 1, wherein the cooking chamber has an opening toward one side of the body, and the window is opened on the other side of the body.

11. An air fryer, comprising a body, a cover and a heating component, wherein the body has a cooking chamber arranged therein, and an installation window arranged thereon and communicated with the cooking chamber, wherein the heating component is detachably arranged in the installation window and is used to heat the cooking chamber, wherein the cover and the body are closed or separated from each other to close or open the installation window.

12. The air fryer, as recited in claim 11, wherein the installation window has a support portion arranged therein, and the heating component is placed above the support portion.

13. The air fryer, as recited in claim 11, wherein the body has a plurality of heat dissipation holes arranged on the side of the heating component.

14. The air fryer, as recited in claim 11, wherein the heating component comprises a fixed cover and a heating tube and a uniform heating fan arranged at a bottom of the fixed cover, wherein a connecting component electrically connected with the heating tube is provided in the installation window, wherein the cover has a motor and a transmission component arranged therein for driving the uniform heating fan.

15. The air fryer, as recited in claim 14, wherein the heating component further comprises a cooling fan arranged on a top of the fixed cover, wherein the cooling fan and the uniform heating fan are connected with the transmission component through a same rotating shaft.

16. The air fryer, as recited in claim 14, wherein the heating component further comprises a protective cover arranged above the fixed cover, and a cavity for installing the cooling fan arranged between the protective cover and the fixed cover, wherein the protective cover has a plurality of exhaust holes and a plurality of water outlet holes arranged thereon and communicated with the cavity.

17. The air fryer, as recited in claim 15, wherein the cover has an installation cavity disposed therein, wherein the motor is arranged in the installation cavity and connected with the rotating shaft through the transmission component.

18. The air fryer, as recited in claim 15, wherein the transmission component comprises a first transmission component and a second transmission component that are allowed to be separated or connected to each other, wherein the first transmission component is provided on an output shaft of the motor, and the second transmission component is provided on the rotating shaft.

19. The air fryer, as recited in claim 18, wherein the first transmission component and the second transmission component are respectively a first clutch and a second clutch; the first transmission component and the second transmission component are respectively a first push rod and a second push rod; or the first transmission component and the second transmission component are respectively a first magnetic component and a second magnetic component.

20. The air fryer, as recited in claim 11, wherein a connection method between the cover and the body is a flip hinge connection, a snap connection, a rotating cover connection or a horizontal sliding connection.

21. An air fryer, comprising an upper pot body, a lower pot body, an upper heating component, and a cooking container, wherein the upper pot body and the lower pot body are covered or separated from each other to form a cooking chamber with different cooking functions, wherein the cooking container is installed in the cooking chamber and used to hold ingredients, wherein the upper heating component is detachably arranged in the upper pot body and used to heat the cooking chamber.

22. The air fryer, as recited in claim 21, wherein the upper heating component comprises a fixed cover, a heating tube, and a uniform heating fan, wherein one side of the fixed cover is detachably arranged on the upper pot body, and the other side of the fixed cover is provided with the heating tube and the uniform heating fan, wherein the upper pot body has a connecting component disposed therein and electrically connected to the heating tube, and a motor and a transmission component disposed therein for driving the uniform heating fan.

23. The air fryer, as recited in claim 22, wherein the transmission component comprises a rotating shaft and a first transmission component and a second transmission component that are allowed to be separated or connected to each other, wherein the uniform heating fan is arranged on the fixed cover through the rotating shaft, the first transmission component is arranged on an output shaft of the motor, and the second transmission component is arranged on the rotating shaft.

24. The air fryer, as recited in claim 23, wherein the first transmission component and the second transmission component are respectively a first clutch and a second clutch; the first transmission component and the second transmission component are respectively a first push rod and a second push rod; or the first transmission component and the second transmission component are respectively a first magnetic component and a second magnetic component.

25. The air fryer, as recited in claim 22, wherein the connecting component comprises a socket and a power connector that match each other, wherein the socket is arranged in the upper pot body, and the power connector is arranged at an end part of the heating tube.

26. The air fryer, as recited in claim 23, wherein the air fryer further comprises a protective cover and a cooling fan, wherein the protective cover is disposed between the upper pot body and the fixed cover, wherein the cooling fan is disposed between the upper pot body and the protective cover and is connected with the output shaft of the motor.

27. The air fryer, as recited in claim 26, wherein the upper pot body has an installation cavity, the motor is installed in the installation cavity, and the output shaft of the motor is connected with the cooling fan and the first transmission component.

28. The air fryer, as recited in claim 21, wherein the lower pot body has a lower baking tray detachably disposed therein, which has a lower heating component at the bottom thereof, wherein when the upper pot body and the lower pot body are closed to each other, the upper heating component or the lower heating component individually cooks the inside of the cooking chamber, or the upper heating component and the lower heating component cooperate with each other to cook in the cooking chamber, wherein when the upper pot body and the lower pot body are separated from each other, the lower heating component cooks the cooking chamber alone.

29. The air fryer, as recited in claim 28, wherein the cooking container is a frying pot or an upper baking tray, wherein the frying pot is placed above the lower baking tray, and the upper baking tray is detachably arranged on the upper pot body and is positioned below the upper heating component.

30. The air fryer, as recited in claim 21, wherein a connection method between the upper pot body and the lower pot body is a flip hinge connection, a snap connection, a rotating cover connection, a horizontal sliding connection or a vertical lifting connection.

31. An oven, comprising a box body and a heating component, wherein the box body has a baking cavity arranged therein, and a window arranged thereon and communicated with the baking cavity, wherein the heating component is detachably arranged in the window.

32. The oven, as recited in claim 31, further comprising a box door hinged with the box body for closing the baking cavity.

33. The oven, as recited in claim 31, wherein the window has a support portion arranged therein, and the support portion has a track arranged on an edge thereof, wherein the heating component is disposed in the window along the track in a drawable manner and is arranged above the support portion.

34. The oven, as recited in claim 31, wherein the heating component comprises a fixed cover and an upper heating tube and a uniform heating fan arranged at a bottom of the fixed cover, wherein the window has a connecting component disposed therein and electrically connected with the upper heating tube, and a motor and a transmission component disposed therein and connected with the uniform heating fan in a transmission manner.

35. The oven, as recited in claim 34, wherein the box body has a mounting groove arranged on a top thereof and connected with the window, wherein the motor is detachably arranged in the mounting groove through a mounting bracket, and is connected with the uniform heating fan through the transmission component.

36. The oven, as recited in claim 35, wherein the transmission component comprises a first transmission component and a second transmission component, which are separable or interconnectable from each other, wherein the first transmission component is disposed on an output shaft of the motor, and the second transmission component is disposed on a rotating shaft of the uniform heating fan.

37. The oven, as recited in claim 34, wherein the oven further comprises a protective cover and a cooling fan, wherein the protective cover is arranged above the fixed cover, and the cooling fan is arranged between the protective cover and the fixed cover, and is connected with the rotating shaft of the uniform heating fan.

38. The oven, as recited in claim 34, wherein the oven further comprises a protective cover and a cooling fan, wherein the protective cover is arranged at a bottom of the motor, and the cooling fan is arranged between the motor and the fixed cover, and is connected with an output shaft of the motor.

39. The oven, as recited in claim 35, wherein the oven further comprises a support cover arranged on a bottom of the mounting groove, wherein the mounting bracket has an elastic buckle arranged on each of two sides thereof, and the support cover has a hook matched to each of the elastic buckles disposed thereon.
